(19) United States
(12) Patent Application Publication
(10) Pub. No.: US 2017/0173993 A1
(43) Pub. Date: Jun. 22, 2017

(54) EDUCATIONAL STICKY YARN MANFACTURING PROCESS BASED ON APPLICATION OF CAMPECHE WAX

(71) Applicant: Julian MACIAS LIZAOLA, Orlando, FL (US)

(72) Inventor: Julian MACIAS LIZAOLA, Orlando, FL (US)

(21) Appl. No.: 15/354,394

(22) Filed: Nov. 17, 2016

(30) Foreign Application Priority Data
Dec. 18, 2015 (MX) MX/U/2015/000637

(51) Int. Cl. B44C 1/00; G09B 19/10

(52) U.S. Cl. CPC B44C 1/005; G09B 19/10

(57) ABSTRACT

It is described as a package for educational and creative manual craft work using Campeche wax as an adherent link between a yarn or other material and a base having printed forms; to place, fix and delimit color, textures, volume and other materials within the limits of the forms.

### TECHNICAL FIELD OF THE INVENTION

The present invention is related to manual crafts mediums, and more specifically to mediums and processes for the manufacture of didactic and decorative crafts.

### BACKGROUND OF THE INVENTION

The Campeche wax is a byproduct of the manufacture of the honey produced by bees of the genus Apis Melipona beecheii Benneth, native bee of mainland America, being without stinger, of the tropical zone, especially in Mexico. It is a mixture of wax with propolis. It is of dark brown color and of sticky and soft consistency. It is insoluble in water and cold alcohol, and can be dispersed in fatty alcohol.

The Campeche wax has various uses: in the production of fruit tree grafts, as adhesive, as well as in the elaboration of ornaments. Also, it is used as an adhesive for craftwork, wood sealer in craftwork, and its primary use is to seal the wounds of trees when they are pruned, to prevent fungi and for sealing the exterior joints in grafting of fruit trees. It also has other traditional uses as a cosmetic ingredient for rejuvenating creams and depilation masks and as a main ingredient in the manufacture of candles and in the artistic manufacture of figures of famous characters from history, art, and modern performances.

It is important to highlight the use applications in the folk art of indigenous people given to the Campeche wax, as adhesive or fixative medium, in feather art works, in ritual cosmological visions rituals made with colored threads of different consistencies over wood frames, pictures and masks adorned with colored chaquiras and beads, of prodigious creative designs, of unique character and hardly repeatable. Such applications of the Campeche wax on the folk art have an aspect consecrated of its own, completely outside the industrial art.

Now, in the modern context of industrial art in the present invention, the applicant of the present poses the integration of a model package and a procedure for the realization of didactic craft and works, based on reproductive tech graphic media and crafts, and using Campeche wax as an adherent medium linking sticky yarn of other material means on a base with printed forms, to place, secure, and define color, texture, volume, and other materials within the margins of such forms.

In the case of the previous art, it cannot mention disadvantages, since the popular indigenous art practically does not include them. In the case of the present invention, it can be said that it is an innovation similar to the use of materials and procedures of the folk art, in which can be used advantageously the additional use of media and modern processes in order to boost the creativity and the people skills of persons of all ages to work on crafts.

An advantage of the present invention is that it integrates a manual craft package at a modest cost, with imitative or creative didactic purposes and stimulating the vision, dexterity, and creativity of people of all ages.

The inventor of the present invention developed a series of experiments, tests, and trials that produced a didactic sticky yarn and its manufacturing process based on application of Campeche wax that is of utmost importance in the engineering part, in which falls the invention.

### OBJECTIVES OF THE INVENTION

It is a main objective of the present invention to provide a manual craft package of modest cost, with imitative didactic purposes or creative and stimulating to the vision, the dexterity, and creativity of people of all ages.

It is another objective of the present invention to provide a process for the manufacturing of the package for the didactic manual craft and creative, using Campeche wax as an adherent medium linked to yarns or other material means over a base with printed forms, to place, secure, and define color, texture, volume, and other materials within the margins of such forms.

### BRIEF DESCRIPTION OF DRAWINGS

For a better understanding of the present invention, it describes a base in a preferred mode illustrated in the figures that accompany this description and in where:

FIG. 1 shows a block diagram of the manufacturing steps of the process of the sticky yarn according to the present invention; and

FIG. 2 shows a block diagram of operations at the fusion step of the Campeche wax.

### PREFERABLE EMBODIMENT OF THE INVENTION

The present invention is described with basis in a preferred embodiment in which:

Is to be understood that the invention is not limited in its application to the details of the construction and the disposition of the components that is set in the presentation or illustration of the drawings.

It is mentioned, unless otherwise specified, all of the technical or scientific terms used in this document have the same meaning that commonly have people with knowledge of the art of the invention. The methods and the examples provided in this document are illustrative and not intended to be a limitation.

Materials used:

Campeche wax

Yarn skeins

A wood stick with a tip that is the applicator for the yarn

A colored print of the completed figure. Cardboard paper of yellow color 180 or 230 grams.

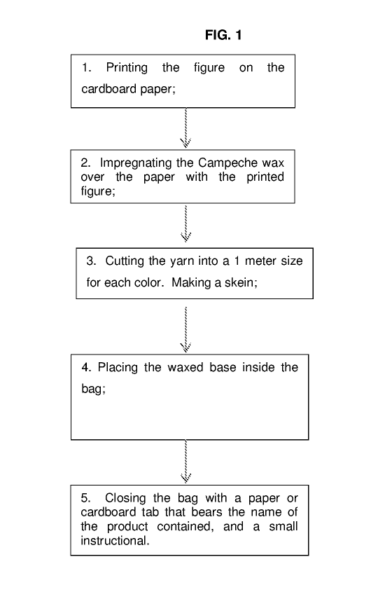

FIG. 1 shows manufacturing steps of the process of the sticky yarn

1. The figure is printed on the cardboard paper with a laser printer as required by the client.

2. After this, the Campeche wax is impregnated over the paper, as the wax needs to be melted.

3. Then, the yarn is cut to a size of a meter for each color. A skein is made with the yarn of each required by the figure.

4. Then, the sticky figure is placed inside a bag.

5. After, the bag is closed with a paper or cardboard tab that bears the name of the product contained, and a small instructional.

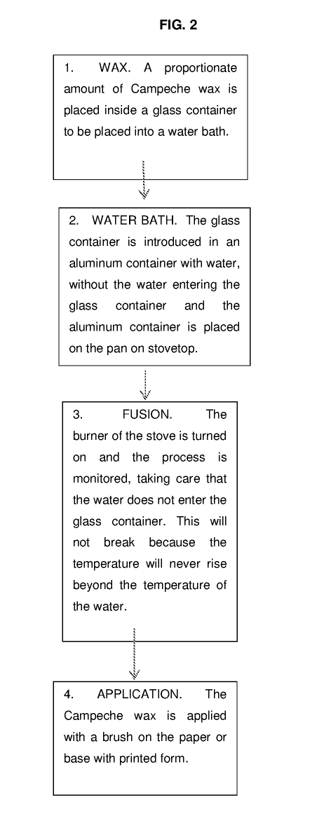

FIG. 2 shows a block diagram of operations at the fusion step of the Campeche wax

1. WAX. A proportionate amount of Campeche wax is placed inside a glass container to be placed into a water bath.

2. WATER BATH. The glass container is introduced in an aluminum container with water, without the water entering the glass container and the aluminum container is placed in the pan on the stovetop.

3. FUSION. The burner of the stove is turned on and the process is monitored, taking care that the water does not enter the glass container. This will not break because the temperature will never rise beyond the temperature of the water.

4. APPLICATION. The burner is turned off and the glass container is removed when the Campeche wax has the consistency of honey and is applied with a brush on the paper or base with printed forms; trying to give the coating thickness that allows to see the figures and at the same time provide an overlay or substrate that can be applied and pasted on the yarn or chosen material.

It will be evident, to those skilled in the art, that innumerable modifications can be made to the present invention without deviating from the spirit and scope of the same; so this must be considered in its broadest sense and not restrictive.

### NOVELTY OF THE INVENTION

Having thus described the invention, it is considered as a novelty and, therefore, is claimed as property in content of the following.

1-6. (canceled)

7. A package for didactic and creative craft comprising:
a bag including:
a Campeche wax;
yarn skeins;
a wooden stick including a tip to apply the yarns;
a base including a colored printed figure, the printed figure including lines that define a contour of the printed figure;
wherein the Campeche wax is used as an adherent to link the yarn over the lines of the contour of the printed figure on the base.

8. The package according to claim 7, wherein the printed forms are obtained through a graphic printing device.

9. The package according to claim 7, wherein the Campeche wax is placed over the printed figure and wherein the yarn is placed on the lines of the contour of the printed figure, using the tip of the wooden stick.

10. The package according to claim 7, wherein the base is construction paper.

11. A process for using the package of claim 7, the process including the steps of:
printing a figure on the base with a laser printer;
melting the Campeche wax;
impregnating the melted Campeche wax over the base;
cutting the yarn into a desired size;
placing the waxed base inside the bag with the cut yarn and the wooden stick;
wherein a user places the pieces of yarn over the lines of the contour of the printed figure using the tip of the wooden stick.

12. The method of claim 11, wherein the Campeche wax is melted by:
placing the Campeche wax inside a glass container;
placing the glass container inside an aluminum container with water;
heating the water until the Campeche wax has a consistency of honey.
